(19) United States
(12) Patent Application Publication
(10) Pub. No.: US 2013/0030905 A1
(43) Pub. Date: Jan. 31, 2013

(54) User-Initiated Boosting of Social Networking Objects

(71) Applicants: Prashant Chandra Fuloria, Los Altos, CA (US); Gokul Rajaram, Los Altos, CA (US)

(72) Inventors: Prashant Chandra Fuloria, Los Altos, CA (US); Gokul Rajaram, Los Altos, CA (US)

(21) Appl. No.: 13/194,507

(22) Filed: Jul. 29, 2011

(51) Int. Cl. G06Q 30/00

(52) U.S. Cl. 705/14.39

(57) ABSTRACT

Methods, apparatuses and systems directed to allowing users of a social networking system to promote specific social networking objects in exchange for payment. In particular embodiments, promoted social networking objects may be exported to a sponsored story system for display in a sponsored story area of the promoting user's friends' home pages. In particular embodiments, the promoted social networking objects may be pinned for a predetermined amount of time, clicks, or impressions at the top of the news feeds for the first degree connections of the promoting user.

### TECHNICAL FIELD

The present disclosure relates generally to social networking systems and other systems in which users can form connections with other users, and in particular, providing a mechanism for users to promote social networking objects to other users.

This disclosure hereby incorporates by reference commonly-owned U.S. utility patent application, U.S. patent application Ser. No. 13/020,745, entitled, “SPONSORED STORIES UNIT CREATION FROM ORGANIC ACTIVITY STREAM,” previously filed on Feb. 3, 2011.

This disclosure hereby incorporates by reference commonly-owned U.S. utility patent application Ser. No. 13/044,506, entitled, “ENDORSEMENT SUBSCRIPTIONS FOR SPONSORED STORIES,” previously filed on Mar. 9, 2011.

### BACKGROUND

Social networks, or social utilities that track and enable connections between users (including people, businesses, and other entities), have become prevalent in recent years. In particular, social networking systems allow users to communicate information more efficiently. For example, a user may post contact information, background information, job information, hobbies, and/or other user-specific data to a location associated with the user on a social networking system. Other users can then review the posted data by browsing user profiles or searching for profiles including specific data. Social networking systems also allow users to associate themselves with other users, thus creating a web of connections among the users of social networking system. These connections among the users can be leveraged by the website to offer more relevant information to each user in view of the users' own stated interests in their connections.

A system, such as a website, that allows users to interact with the system typically stores a record for each user of the system. These records may comprise information provided by the user as well as information gathered by the system related to activities or actions of the user on the system. For example, a system may require a user to enter information such as contact information, gender, preferences, interests, and the like in an initial interaction with the system, which is stored in the user's record. A user's activities on the system, such as frequency of access of particular information on the system, also provide information that can be stored in the user's record. The system may then use information provided by the user and information gathered about the user, to customize interactions of the system with the user. For example, a website selling books may keep track of a users previous purchases and provide the user with information on related books during subsequent interactions with the system. Information in a user's profile may also be used by the system to target sponsored stories that are of interest to the user. Using information collected from and about users results in a system that is more efficient and beneficial for both the user and the system.

Users interacting with the social network may post stories or status updates to a live activity stream, such as a “news feed.” A news feed is a data format typically used for providing users with frequently updated content. A social networking system may provide various news feeds to its users, where each news feed includes content relating to a specific subject matter or topic, and/or other users. Various pieces of content may be aggregated into a single news feed. In some implementations, a social networking system may provide a news feed that includes selected entries corresponding to activities of a user's first-degree contacts and/or pages or topics that a user has indicated an interest. Individual users of the social networking system may subscribe to specific news feeds of their interest. A group of related actions may be presented together to a user of the social networking system in the same news feed. For example, a news feed concerning the event organized through the social networking system may include information about the event, such as its time, location, and attendees, and photos taken at the event, which have been uploaded to the social networking system.

Generally, news feeds are customized for each member; only the status updates and stories posted by their connections are displayed. In this manner, members of the social network may quickly access their direct connections' status updates, story postings, and other interactions with the social network in a single stream, obviating the need to individually check their connections' profile pages.

Other users may choose to promote or express an affinity for their own or others' stories appearing in their news feed. For example, a first user may upload a photo to the social networking system, and the photo may be displayed to friends or first-degree connections of the first user in the friends' individual news feeds. A friend viewing the photo story may choose to express his affinity for the story by clicking a “like” button for the photo. Users may express an affinity for essentially any piece of content or story on the social networking system, including but not limited to individual photos, photo albums, videos, status messages, shared links, notes, and comments by users on other content. For the purposes of this disclosure, any object which may be liked or otherwise interacted with by a user on the social networking system is herein referred to as a “social networking object.”

However, given the vast number of contacts the average member of a social network has, and the prodigious amounts of status updates posted by users, it is possible that even “liked” social networking objects of interest to the user are lost in the unending stream of their newsfeed. Thus, a particular member may wish to pay for increased permanence of a particular social networking object in other members' newsfeeds; this functionality unavailable in typical social networking systems.

In particular embodiments, user-promoted social networking objects may be displayed to other members via the other members' home page on the social network, mobile devices, third-party webpages and applications, television and other video streams, or any other particular display accessed by a member of the social network. In particular embodiments, user-promoted stories may be displayed to other members via a particular area of the other members' home pages, such as an advertisement space. In particular embodiments, the user-promoted social networking objects or content may be displayed to other members by pinning the story or content to the top of each other member's news feed.

### BRIEF DESCRIPTION OF THE DRAWINGS

FIG. 1 illustrates the architecture of an example social network.

FIG. 2 illustrates the hardware components of an example social network.

FIG. 3 is depicts the interaction between the organic activity stream and the sponsored story application in accordance with one embodiment of the disclosure.

FIG. 4 illustrates a method for user-promoting content to an sponsored story space.

FIG. 5 illustrates an example method for calculating a measure of affinity.

FIG. 6 illustrates an example system architecture for implementing the method of FIG. 5.

FIG. 7 depicts a method for user-promoting content by pinning the content to the top of a news feed.

FIG. 8A depicts an example home page for a user.

FIG. 8B depicts an example dialog box permitting the user of FIG. 8A to promote her own content.

FIG. 8C depicts an example user-promoted sponsored story.

FIG. 9A depicts an example home page for a user.

FIG. 9B depicts an example dialog box permitting the user of FIG. 9A to promote content from other users.

FIG. 9C depicts an example piece of user-promoted content pinned to the top of a news feed.

FIG. 10 illustrates an example computer system.

The figures depict various embodiments of the present disclosure for purposes of illustration only. One skilled in the art will readily recognize from the following discussion that alternative embodiments of the structures and methods illustrated herein may be employed without departing from the principles of the invention described herein.

### DETAILED DESCRIPTION OF EXAMPLE EMBODIMENT(S)

### Overview

Particular embodiments relate to a social networking environment including a social networking system and related systems that integrate individual stories, status updates, and user interactions with an advertising and sponsorship system. A social networking system offers its users the ability to communicate and interact with other users of the social networking system. Users join the social networking system and then add connections to a number of other users to whom they desire to be connected. Once they are members of the social network, the users may interact with the social network itself, by posting stories and status messages on their own page, other users, by commenting, posting stories, etc. on other users' pages, or with non-user entities, such as fan pages that they subscribe to, online deals they redeem or subscribe to, or locations that they check in to.

Implementations of the present disclosure extend these concepts by allowing specific users to promote specific newsfeed stories to other users' social networking pages, thereby increasing the relative persistence and viewing frequency of these social networking objects. In one example, a user may want to promote one of his or her own social networking objects so that more of the user's connected friends can see the story in a more frequent and permanent view. For example, a user may wish to promote a status message, photo, or cause to his or her first-degree connections. Upon paying for the promotion of the content, the story may be pinned to the top of his first-degree connections' news feeds for a predetermined amount of time, or prominently displayed in a sponsored stories area of his first degree connections' home pages. Other embodiments are readily envisioned by the disclosure and are described in detail below.

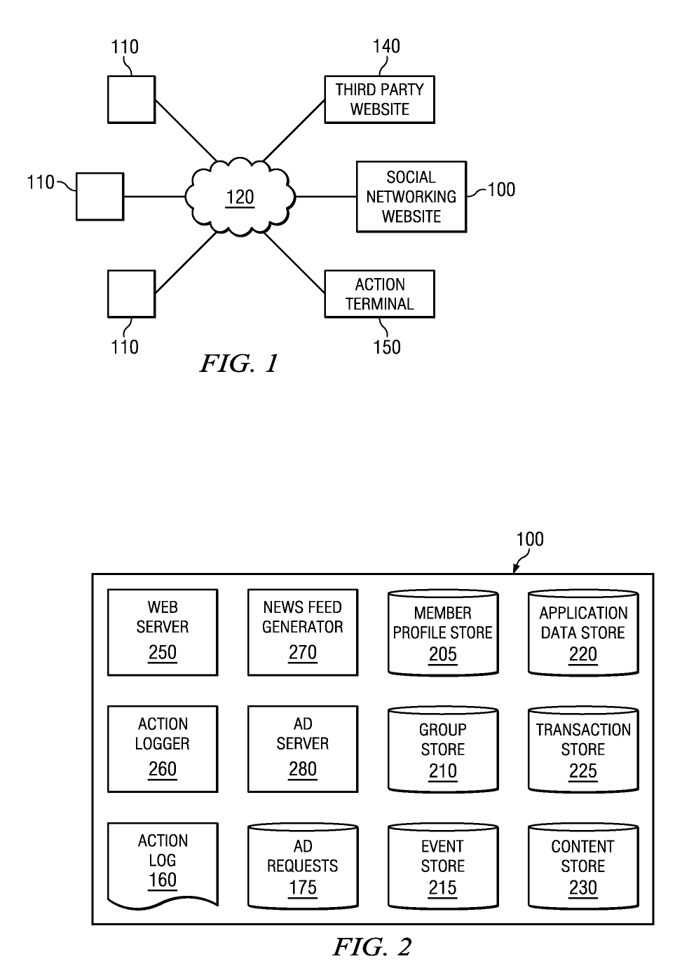

FIG. 1 is a high-level block diagram illustrating a system environment suitable for operation of a social networking system 100. The system environment comprises one or more client devices 110, one or more third-party websites 140, a social networking system 100, and a network 120. In alternative configurations, different and/or additional modules can be included in the system.

Client devices 110 comprise one or more computing devices that can receive member input and can transmit and receive data via network 120. For example, client devices 110 may be desktop computers, laptop computers, smart phones, personal digital assistants (PDAs), or any other device including computing functionality and data communication capabilities. Client devices 120 are configured to communicate via network 120, which may comprise any combination of local area and/or wide area networks, using both wired and wireless communication systems. Third party website 140 and action terminal 150 are coupled to network 120 for communicating messages to social networking system 100 about the members' actions off website 100.

Social networking system 100 comprises a computing system that allows members to communicate or otherwise interact with each other and access content as described herein. Social networking system 100 stores member profiles that describe the members of a social network, including biographic, demographic, and other types of descriptive information, such as work experience, educational history, hobbies or preferences, location, and the like. Website 100 further stores data describing one or more relationships between different members. The relationship information may indicate members who have similar or common work experience, group memberships, hobbies, or educational history. Additionally, the social network host site 120 includes member-defined relationships between different members, allowing members to specify their relationships with other members. For example, these member-defined relationships allow members to generate relationships with other members that parallel the members' real-life relationships, such as friends, co-workers, partners, and so forth. Members may select from predefined types of relationships, or define their own relationship types as needed.

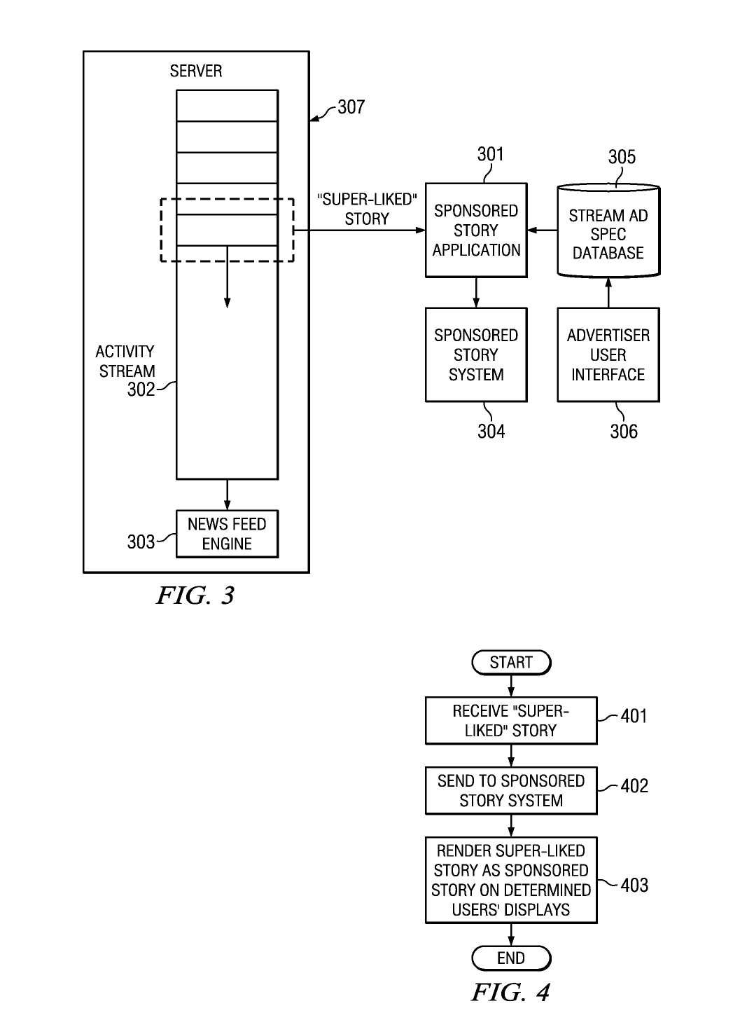

FIG. 2 is an example block diagram of a social networking system 100. Social networking system 100 includes a web server 250, an action logger 280, an action log 180, a newsfeed generator 290, an ad server 280, a database of ad requests 195, a member profile store 205, a group store 210, an event store 215, an application data store 220, a transaction store 245, and a content store 230. In other embodiments, social networking system 100 may include additional, fewer, or different modules for various applications.

Web server 250 links social networking system 100 via network 220 to one or more client devices 210, as well as to one or more third party websites 140. Web server 250 may include a mail server or other messaging functionality for receiving and routing messages between social networking system 100 and client devices 210 or third party websites 140. The messages can be instant messages, queued messages (e.g., email), text and SMS messages, or any other suitable messaging technique.

Action logger 280 is capable of receiving communications from the web server 250 about member actions on and/or off social networking system 100. Newsfeed generator 290 generates communications for each member about information that may be relevant to the member. These communications may take the form of stories, each story is an information message comprising one or a few lines of information about an action in the action log that is relevant to the particular member. The stories are presented to a member via one or more pages of the social networking system 100, for example in each member's home page or newsfeed page.

Ad server 280 performs an ad selection algorithm 170. Ad server 280 is communicatively coupled to the database of ad requests 175 and to action log 160 for this purpose.

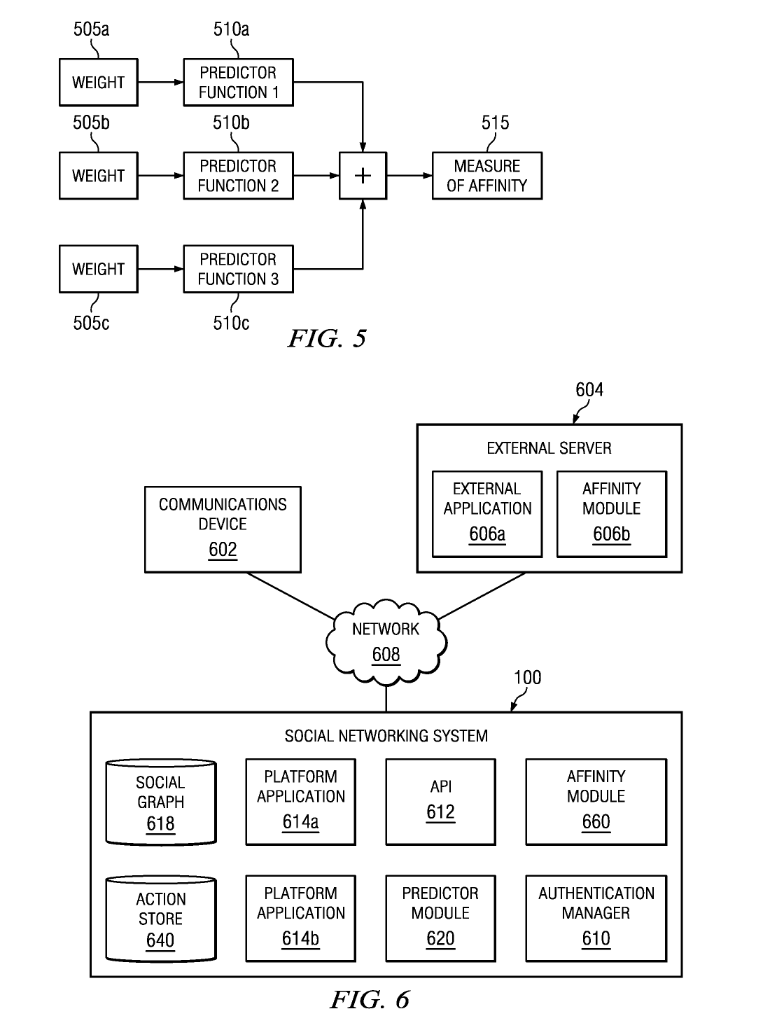

FIG. 3 shows the interaction between sponsored story application 301 and an activity stream 302. In particular embodiments, sponsored story application 301 may be software residing within the sponsored story system 304, or part of the stream sponsored story database 305. In particular embodiments, sponsored story application 301 may be software executed by any number of servers in the social networking system, either in conjunction or in isolation. In particular embodiments, sponsored story application 301 may reside on its own dedicated hardware. Activity stream 302 comprises the aggregate stream of status updates and news stories for all users of a social network. Activity stream 302 under normal operation passes to news feed engine 303, which parses the individual stories in activity stream 302 and determines which users' (generally the friends of the user who generated the story) pages to display each story on. In particular embodiments, both activity stream 302 and newsfeed engine 303 are applications residing in server 307. In particular embodiments, activity stream 302 or newsfeed engine 303 are applications distributed across one or more computing servers. This disclosure contemplates any suitable implementation of activity stream 302 and newsfeed engine 303.

Typically, a sponsor uses Sponsor GUI 306 to specify the type of stories it wants promoted to the sponsored story section of users' pages. The Sponsor GUI 306 provides a method for the sponsor to create story filters to locate specific types of news feed stories for promoting to the sponsored story space of a user's home page. Once the sponsor sets up its preferences for the types of stories it wishes to promote to the sponsored story portion, the sponsor specifications are stored into stream sponsored story specification database 305. However, user-promoted social networking objects differ from sponsored stories because they are not recurring, and therefore, a sponsored story specification is not necessary. Thus, when a user selects a story for user-promotion, it is automatically exported from activity stream 302 to sponsored story application 304, and entered into sponsored story 304. In other implementations, a user may configure a filter that defines the types of social network objects the user desires to sponsor, such as all photo uploads associated with one or more defined tags. In some implementations, the user may sponsor content objects created by that user or other users. In some implementations, privacy settings may control the extent to which a content object created or associated with a first user can be sponsored by a second user. For example, the social networking system 100 may offer the users a “allow others to sponsor my content” control.

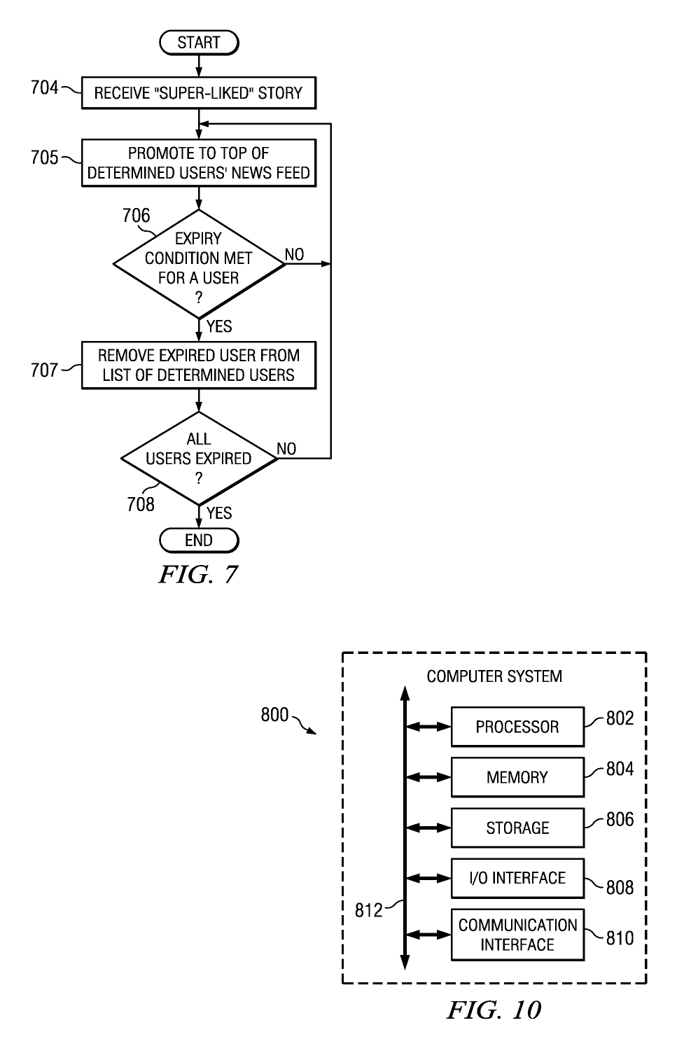

FIG. 4 depicts the an example method of displaying a user-promoted story or piece of content via sponsored story application 301 and sponsored story system 304. In step 401, sponsored story application 301 receives a promoted social networking object from a user. In particular embodiments, promoted social networking objects may be called “super liked” social networking objects. In particular embodiments, social networking system 100 provides users a button for each story or piece of content allowing the user to “like” or “super-like” a given story or piece of content. In particular embodiments, the “super like” button is a pop-up dialog box that appears after a user has “liked” a social networking object prompting the user as to whether he or she would like to feature or “super like” the content for a given price. In particular embodiments, the probability of the “super-like” button appearing is based off social relevancy factors, such as whether the story is likely to be promoted by another user. For example, in particular embodiments, a social coefficient representing the degree of “closeness” between two users on the network may be utilized in determining whether to provide the “super-like” interface; two users who are close, and therefore have a high social coefficient, are more likely to promote each others' social networking objects. In particular embodiments, social networking system 100 takes into account the type of social networking objects and determines whether to provide the “super like” interface based on the story type. For example, personal milestones, such as starting a new job, having a change in relationship status, having a child or posting pictures relating thereto, are likely to be promoted by the user or other users. In particular embodiments, the determination as to whether to display the super-like button to a particular user depends on that user's prior credit or spending history; users who promote a large number of stories, or consistently promote stories pertaining to a particular subject, are more likely to promote similar stories in the future, and social networking system 100 should therefore display the “super-like” interface more frequently to such users. This disclosure contemplates any suitable method of providing an interface to a user for promoting social networking objects.

When a user clicks the “super-like” or promotion button, the account associated with the user may be debited a predetermined number of credits. In particular embodiments, credits are equivalent to real-world currency. In particular embodiments, credits are valueless electronic currency that may only be used on the social networking system. In particular embodiments, credits may be utilized for games to purchase virtual goods, for international Voice-over-IP phone calls, for video chats, and the like. In particular embodiments, the credits are deducted after the promoted social networking object is delivered to various users, based on the delivery. For example, the social networking system may deduct the credits based on a cost per impression (CPM), effective cost per impression (eCPM), cost per click (CPC), or cost per action (CPA) pricing model. This disclosure contemplates any suitable payment system for promoting social networking objects.

In step 402 the “super-liked” or promoted social networking object is transmitted to sponsored story system 304. The “super-liked” story is priced and directed toward users in a similar manner as a social ad. In particular embodiments, sponsored story system 304 may also add a weight to the story to alter its direction toward users. For example, certain stories may decay quickly, such as check-ins, and are not displayed to other users beyond a predetermined threshold time period from the story generation. In other embodiments, user-specified temporal factors, such as deadlines, may increase the weight of the sponsored story so that it is promoted over other sponsored stories lacking time sensitivity.

In particular embodiments, ad targeting is based upon an affinity score calculated by social networking system 100. A member may have affinities for other members, types of actions, types of objects, and content. Accordingly, a calculated affinity score may be based on a weighted function that takes into account the set of affinities for the particular member for each type of data field that is in a candidate story. The website may obtain a member's affinities based on the member's express interests (whether provided directly or indirectly, for example, through communications with other members) and/or impliedly based on the member's actions (e.g., a member's checking of another member's page indicates an interest in that other member, or clicking on particular types of links may indicate an interest in similar links). An affinity, as measured for example by an affinity score, need not be an actual subjective interest or lack of interest that a member has for something (i.e., the member likes punk rock music, and dislikes vegetarian restaurants), but rather it may merely be a correlation between something in the candidate story and some information stored in connection with that member, whether is an action taken by the member, a communication involving the member, a characteristic, feature or expressed interest in the member's profile.

In one embodiment, a process running in a social networking environment requests a measure of affinity for a particular user from a module that implements an affinity function. The module, in one implementation, computes the requested measure of affinity by combining (e.g., adding) a weighted set of predictor functions, where each predictor function predicts whether the user will perform a different action. The weights may be provided by the process that requests the measure of affinity, which allows the requesting process to weight the predictor functions differently. In this sense, the affinity function is tunable by the requesting process for its own purpose. In one implementation, affinities may be computed for the purposes of displaying a user-promoted social networking object to one of the promoting user's first-degree connections.

The predictor functions may predict whether a user will perform a particular action based on the user's interest in the action. For example, a predictor function may be derived based on a user's historical activity (such as interacting with other users' promoted social networking objects, for example). Additionally, the predictor function may include a decay factor that causes the strength of the signal provided by the user's historical activity to decay with time. The predictor functions may predict any number of actions, which may be within or outside of the social networking system. For example, these actions may include various types of a user's communications, such as messages, posting of content, and commenting on content; various types of a user's observation actions, such as viewing profiles of other connections and viewing photos and content posted by other connections; and various types of coincidence information about two or more users, such as being tagged in the same photograph, checked in at the same location, and attending the same event. A predictor function may be determined using a machine learning algorithms trained on historical activity and past user responses or data farmed from users by exposing them to various options and measuring responses.

To predict the likely actions a user may take in a given situation, any process on the social networking system 100 or outside may request a measure of affinity for a user by providing a set of weights. The measure of affinity may reflect the user's interest in other users, content, actions, advertisements, or any other objects in the social networking system. The weights may be binary or, more generally, any real number. In particular embodiments, the affinity between the promoting user and one of his or her first-degree contacts is calculated based on the degree of historical on and off-network actions between the two users.

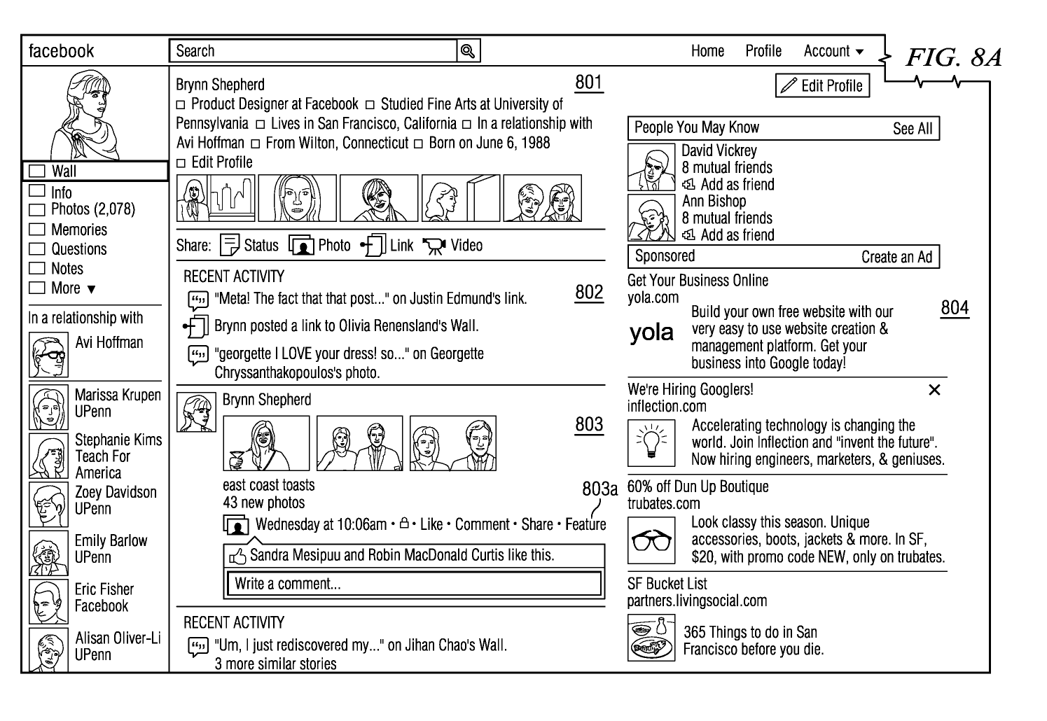

FIG. 5 is a block diagram of a function for computing a measure of affinity for users in a social networking system. To compute a measure of affinity 515 that indicates a set of likely actions a user may want to take in any given situation, weights 505 are applied to predictor functions 510 and then combined to obtain a measure of affinity 515. Although FIG. 5 shows three predictor functions 510, any number of predictor functions can be employed in other embodiments of the invention. Additionally, in the embodiment of FIG. 5, the weighted predictor functions 510 are combined linearly. In different embodiments, other forms of combination may be used, including harmonic means, mean squares, and geometric means. Additionally, multiple measures of affinity 515 with varying weights 505 may be computed before predicting a user's actions.

The weights 505 of the affinity function enable it to be used by various processes in the social networking system environment for different purposes. For example, when determining to which of a promoting user's friends to display a promoted social networking object, an ad algorithm may use the measure of affinity 515 function to determine which of a user's connections have the highest probability of being interested in the promoted social networking object. The measure of affinity 515 may then be based on those predictor functions 510 that show how interested the user is in viewing the content posted by another user as well as one or more predictor functions 510 that show how interested the user is in various actions that may be mentioned in the social endorsement. The ad algorithm would thus provide relatively large weights for these predictor functions 510 so that the resulting measure of affinity would more accurately determine which social endorsements would be more interesting to the viewing user. The ad algorithm would then select display the promoted story to the determined friends.

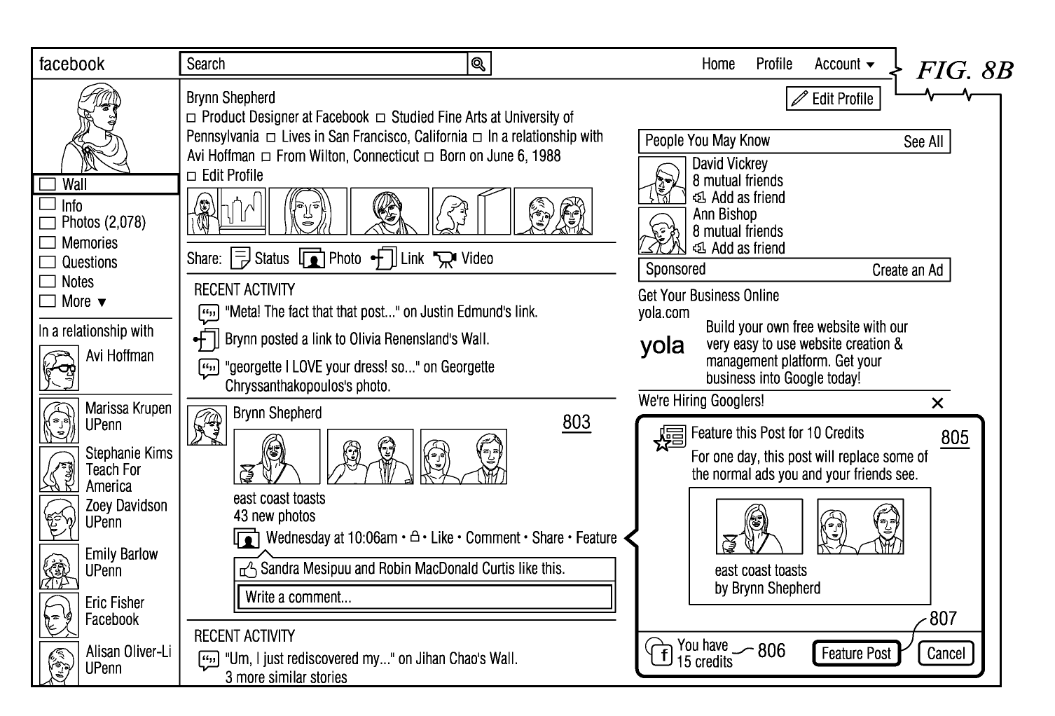

FIG. 6 is a high-level block diagram of an environment of a social networking system, according to one embodiment. FIG. 6 illustrates a social networking system 100, a user device 602, and an external server 605 connected by a network 608. The social graph 618 stores the connections that each user has with other users of the social networking system 100. The social graph 618 may also store second-order connections, in some embodiments. The connections may thus be direct or indirect. For example, if user A is a first-order connection of user B but not of user C, and B is a first-order connection of C, then C is a second-order connection of A on the social graph 618.

The action store 650 stores actions that have been performed by the users of the social networking system 100, along with an indication of the time associated with those actions and references to any objects related to the actions. Additionally, the action store 650 may store statistics for specified categories of actions. For example, for a given user the action store 650 may contain the number of wall posts in 30 days by a user, messages sent by the user, number of photos posted by the user in 30 days and number of distinct users that received the user's comments in 30 days. For a given connection between two users, user A and user B, the action store 650 may contain actions such as the number of profile page views from A to B, the number of photo page views from A to B, the number of messages from A to B, and the number of times A and B were tagged in the same photo, and these actions may be associated with a timestamp or may be filtered by a cutoff (e.g., 25 hours, 90 days, etc.). The actions recorded in the action store 650 may be farmed actions, which are performed by a user in response to the social networking system 100 providing suggested choices of actions to the user.

The predictor module 620 is responsible for computing a set predictor functions 510, which predict whether a user will perform a set of corresponding actions. As discussed above, each predictor function 510 may be representative of a user's interest in a particular action associated with the predictor function 510. The historical activity of a user may be used as a signal of a user's future interest in the same activity. In some embodiments, the predictor function 810 is generated using a machine learned algorithm that is trained using a user's historical activity associated with an action. The predictor module 620 thus provides a predictor function 510 for each of a set of actions, where a predictor function 510 may take as an input the a user's historical activity and then outputs a measure of the likelihood that the user will engage in the corresponding activity.

In some embodiments, one or more of the predictor functions 510 may use a decay factor in which the strength of the signal from a user's historical activity decays with time. Moreover, different predictor functions 510 may decay the historical activity at different rates. For example, some types of user activity, like adding a new connection, indicate a more persistent interest than other types of activity that indicate a more ephemeral interest, like commenting on another user's status. Therefore, the predictor functions 510 may decay the effect of historical activity based on an understanding about how that activity may become less relevant over the passage of time. Various decay mechanisms may be used for this purpose. For example, a predictor function 510 may use a mathematical function, such as an exponential decay, to decay the statistics about a user behavior. In another embodiment, the decay is implemented by selecting only those statistics about a user behavior that occurred within a specific window of time, such as 25 hours or 30 days.

In one embodiment, a predictor function 510 is realized as a ratio of two affine functions as shown in equation (1). The numerator and denominator affine functions take statistics of the user's historical activity as inputs.

$$P = \frac{{a}_{0} + {a}_{1} {x}_{1} + {a}_{2} {x}_{2} + … + {a}_{n} {x}_{n}}{{b}_{0} + {b}_{1} {x}_{n + 1} + … + {b}_{m} {x}_{n + m}} \qquad ( 1 )$$

where
P is the predictor function 510;
aᵢ for i=0,1,2, . . . , N are the coefficients in the numerator affine function;
bᵢ for i=0,1,2, . . . , M are the coefficients in the denominator affine function; and
xᵢ for i=1,2, . . . , N+M are the statistics on a user's historical activity related to the predictor function P.

In particular embodiments, the various predictor functions are utilized to calculate a degree of affinity between two users in order to determine whether or not to display a user-promoted story to one of his or her first-degree connections. For example, if user A promotes a story generated by user B, naturally, the story will be pinned to the top of the newsfeed of some of the friends of both users A and B. However, affinity scores may be calculated for this set to determine which are closest to both users A and B, and the newsfeed story will be pinned to the top of the determined users newsfeeds. As another example, user A may promote one of his or her own stories pertaining to a specific hobby. The predictor functions may be utilized to determine which of the friends of user A also share an interest in the same specific hobby. Thus, the predictors functions may be utilized to tailor delivery of promoted social networking objects to users who have the greatest interest in the social networking object.

In particular embodiments, “super-liked” or promoted social networking objects are displayed in the advertisement or sponsored story space of particular users' homepages. In particular embodiments, when a user “super-likes” a social networking object, the story is displayed on the user's own page, as well as any users who are first-degree connections (“friends”) with the user. In particular embodiments, the advertisement system adjusts the display of the “super-liked” story based upon social factors as well as the real-world value of the credits paid. For example, if a user has a large number of first-degree connections and the value of the credits paid is insufficient to fund the display of the “super-liked” story to all of the user's first degree connections, the ad system may display the story to a subset of users for which the social networking object is the most relevant, such as family, close friends, or first-degree connections in the same geographic area. Conversely, if a user does not have a large number of first-degree connections, the ad bidding algorithm may re-bid the “super-liked” story into the ad system for increased temporal duration. In particular embodiments, the “super-liked” story may be displayed for a predetermined amount of time, such as one day to one week. In particular embodiments, the ad system displays the “super-liked” story until each of the user's first degree connections has seen the story once. This disclosure contemplates any suitable manner of bidding promoted social networking objects into an advertisement system, and any suitable manner or duration of display of the promoted social networking object.

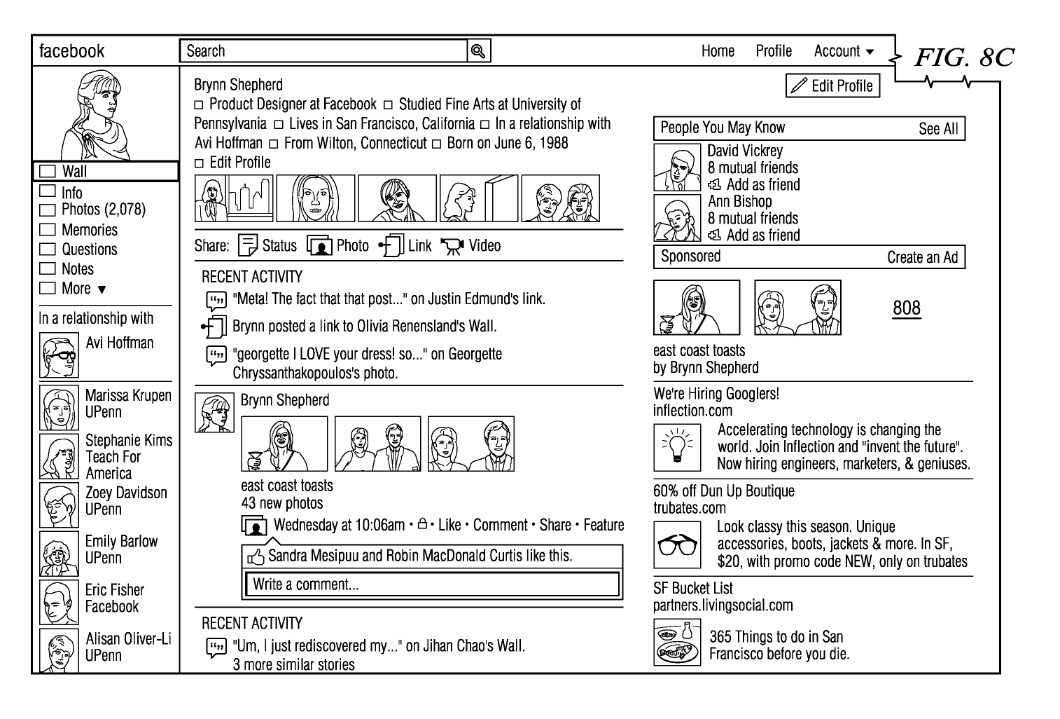

FIG. 7 illustrates an alternative method of displaying a promoted social networking object by pinning the story to the top of viewing users' news feeds (typically where the most recent or most socially relevant news feed stories are displayed). In particular embodiments, the method of FIG. 5 bypasses sponsored story application 301 and sponsored story system 304; instead the “super-liked” story is directly promoted to the top of viewing users' news feeds via newsfeed engine 303. In particular embodiments, a dedicated “super-like” application may perform the story promotion. This disclosure contemplates any manner of software or hardware for carrying out the method of FIG. 7.

Step 704 is substantially identical to step 401 of FIG. 4. After the promoting user's account has been debited the predetermined amount of credits or currency, social networking system 100 at Step 705 pins the “super-liked” story to the top of all the promoting user's friends' newsfeeds. Thus, the story will appear at or near the top of the viewing users' news feeds regardless of how many stories are generated by the viewing users' first-degree connections. Thus the probability that the friends of the promoting user view the “super-liked” story increases drastically.

At step 706, social networking system 100 evaluates, for each of the promoting user's first-degree connections, whether to continue pinning the “super-liked” story to the top of their news feed. In particular embodiments, the expiration condition is a timer, and the “super-liked” story is un-pinned from the top of the viewing users' news feeds when the timer expires. For example, a “super-liked” story may be displayed for 48 hours from the time of promotion, after which the story reverts to a normal newsfeed story and is placed in its chronological order on viewing users' newsfeeds. Because, in particular embodiments, the news feed for each user is personalized, each viewing users' news feed appears differently after the expiry event. For example, if a user has no first degree connections generating stories after the generation of the “super-liked” story, that user's news feed would remain unchanged after the “super-liked” story reverts to a regular newsfeed story. Conversely, if a user has a large number of first-degree connections generating newsfeed stories after the “super-liked” story, then the “super-liked” story may not show up at all on the user's news feed after reversion to a regular newsfeed story.

In particular embodiments, the expiry condition is not time-dependent, but view, or “impression” dependent. For example, the “super-liked” story may be pinned to the top of the newsfeeds for the first-degree connections of the promoting user for one view, or upon the next login. In particular embodiments, the expiry condition is “click dependent”, meaning the promoted social networking object remains pinned to the top of a friend of the promoting user's newsfeed until that friend clicks the promoted story. When that expiry condition is met at Step 706, the user who has seen the “super-liked” story is removed from a list of determined users (in most cases, the friends of the promoting user) at Step 707. This process repeats as more users view the “super-liked” story. Thus, social networking system 100 guarantees the promoting user that each of his or her friends will be shown the “super-liked” story at least once. In particular embodiments, this number may be greater, such as five times. At Step 708, when all users have viewed the promoted social networking object the required number of times, the process ends and the “super-liked” story reverts to a normal newsfeed story.

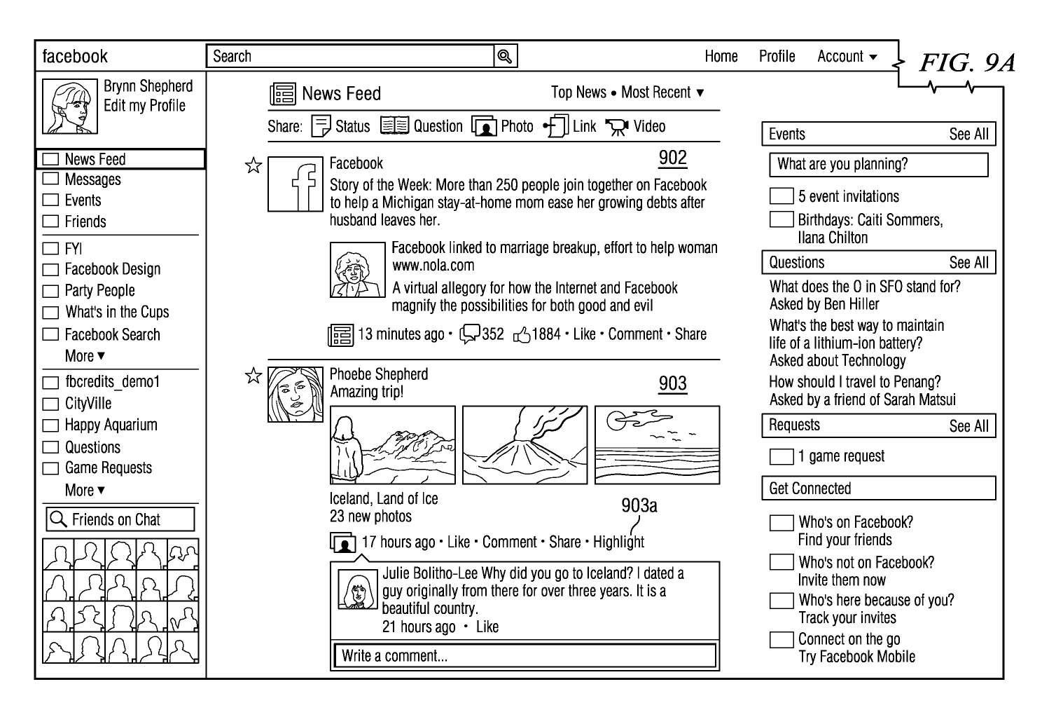

FIG. 8A depicts the news feed 802 of a hypothetical user, “Brynn Sheperd.” The homepage for Brynn Sheperd includes a basic information section 801, listing her position, education information, etc., as well as a news feed 802, which includes individual stories from other users as well as her own stories. For example, newsfeed 802 includes a photo story 803 relating to a set of photos Brynn herself uploaded to the album, “east coast toasts.” Photo story 803 also includes the customary “like”, “comment”, and “share” buttons, allowing a viewer of photo story 803 to express an affinity for the story, comment on the album, or relink the album on his or her own feed, respectively. Photo story 803 includes “feature” button 803a, which allows the user to promote the photo story. In particular embodiments, “feature” button 803a may be a “super-like” button. The homepage also includes a sponsored stories area 804, where stories from sponsors, advertisers, and other users are displayed.

FIG. 8B depicts news feed 802 after the user, in this case a person logged in as Brynn Sheperd, clicks on “Feature” button 803a. After clicking “Feature” button 803a, social networking system 100 displays dialog box 805 to the user. Dialog box 805 prompts the user as to whether he or she would like to feature the post for 10 credits. Dialog box 805 also includes credit balance 806 and confirmation button 809. The user may click confirmation button 809 to promote the social networking object, in this case photo story 803.

FIG. 8C depicts news feed 802 after the user clicks confirmation button 809. Photo story 803 is promoted and displayed as a sponsored story 808 in sponsored story space 804 of the user's homepage. Although FIG. 8C depicts the home page of Brynn Sheperd's account, in particular embodiments, all of Brynn Sheperd's first-degree contacts also see sponsored story 808 on the sponsored story space of their homepage. Thus, a particular user may promote his or her own content for increased exposure to his or her first-degree contacts.

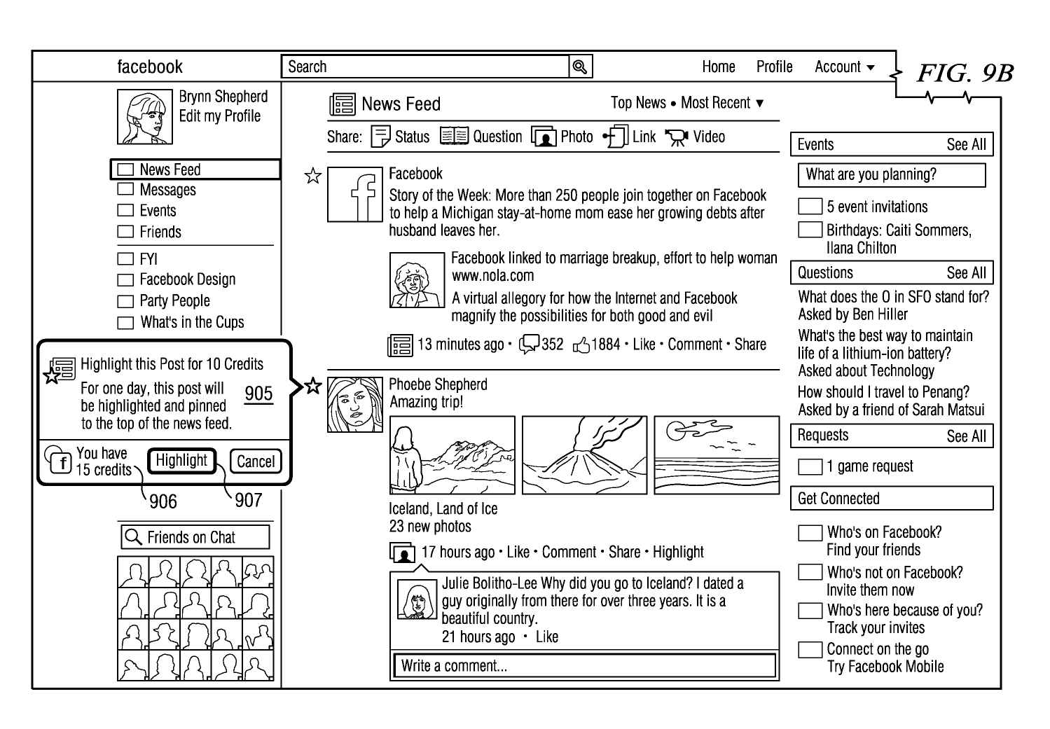

FIG. 9A depicts another example newsfeed 902 for Brynn Sheperd. Newsfeed 902 includes photo story 903 generated by one of Brynn Sheperd's friends, in this case, “Phoebe Sheperd's” uploaded photo album, “Iceland, Land of Ice.” Photo story 903 may also include a “highlight” button 903a. In particular embodiments, “highlight” button 903a is interchangeable with “Feature” button 803a or a “super-like” button.

FIG. 9B depicts the example news feed 902 of FIG. 9A after a user logged in as Brynn Sheperd clicks “highlight” button 903a. Social networking system 100 displays a dialog box 905 which prompts the user as to whether he or she wishes to highlight photo story 903 for a set number of credits. Dialog box 905 also includes the user's credit balance 906, as well as a confirmation button 907.

FIG. 9C depicts an example news feed 902 of FIG. 9A after a user logged in as Brynn Sheperd clicks confirmation button 907. Photo story 903 is pinned to the top of newsfeed 902 as a highlighted story 908 for a duration determined by social networking system 100. In particular embodiments, highlighted story 908 may also include an indicator 908a that the story is a highlighted story. Thus, the present invention allows users to promote their own or their friends' stories to a sponsored story space, or pin the story to the top of the news feed. For example, a friend of Brynn Sheperd, when viewing his or her own news feed, may have highlighted story 908 pinned to the top of his or her news feed for a predetermined duration. As another example, a friend of Brynn Sheperd may also or alternatively have featured story 808 displayed in a sponsored stories area of his or her homepage.

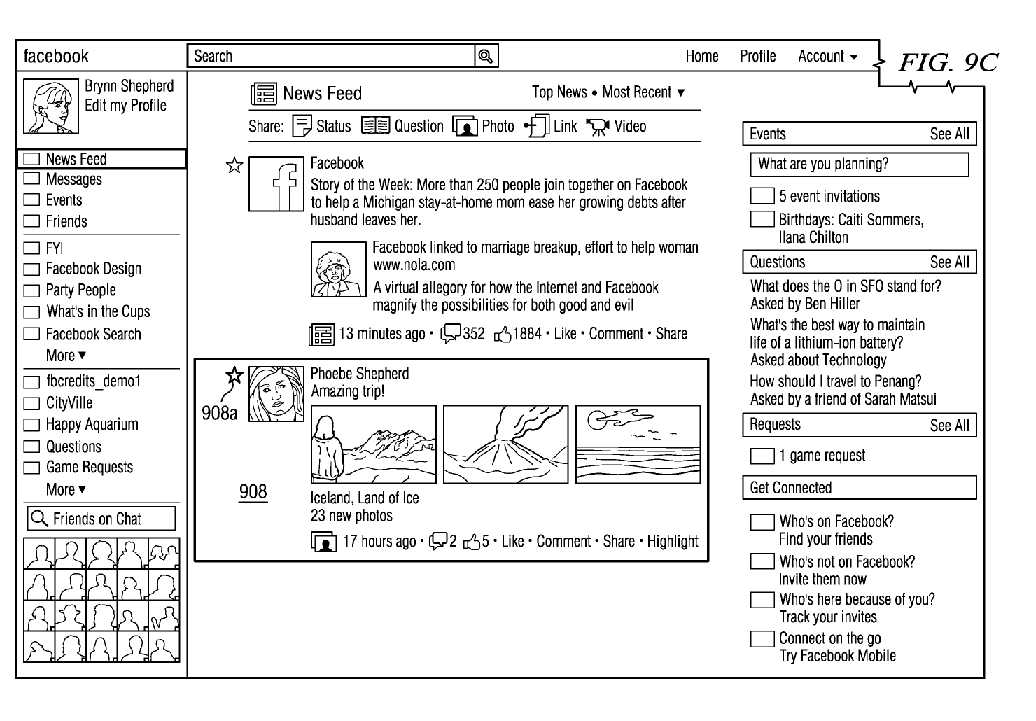

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple datacenters; or reside in a cloud, which may include one or more cloud components in one or more networks.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 10010 or another source (such as, for example, another computer system 1000) to memory 1004. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include an HDD, a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006

In particular embodiments, I/O interface 1008 includes hardware, software, or both providing one or more interfaces for communication between computer system 1000 and one or more I/O devices. Computer system 1000 may include one or more of these I/O devices, where appropriate. One or more of these I/O devices may enable communication between a person and computer system 1000. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. This disclosure contemplates any suitable bus or interconnect.

Herein, reference to a computer-readable storage medium encompasses one or more non-transitory, tangible, computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 802 (such as, for example, one or more internal registers or caches), one or more portions of memory 804, one or more portions of storage 808, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social network system, it will apparent to one of ordinary skill in the art that the invention may be used with any electronic social network service and, even if it is not provided through a website. Any computer-based system that provides social networking functionality can be used in accordance with the present invention even if it relies, for example, on e-mail, instant messaging or other form of peer-to-peer communications, and any other technique for communicating between users. The invention is thus not limited to any particular type of communication system, network, protocol, format or application.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, by one or more computing systems:
receiving, from a first user of a social networking system, a request to sponsor content, the request comprising an identifier for one or more social networking objects viewable by other users of the social networking system;
promoting the one or more social networking objects to the other users of the social networking system; and
debiting an account of the first user based on the promoting of the one or more social networking objects.

2. The method of claim 1, wherein promoting the one or more social networking objects comprises pinning the one or more social networking objects to a predetermined location of a personalized activity stream for each of the other users.

3. The method of claim 2, wherein the one or more social networking objects are promoted for a predetermined amount of time.

4. The method of claim 3, wherein the predetermined amount of time is a predetermined number of log-ins to the social networking system.

5. The method of claim 1, wherein the payment is a predetermined amount of credits.

6. The method of claim 1, wherein promoting the one or more social networking objects comprises weighing the one or more social networking objects more heavily in a content ranking algorithm.

7. The method of claim 6, wherein the content ranking algorithm is based on at least a coefficient between a first node representing the first user and each of a set of second nodes, each second node representing one of the other users.

8. The method of claim 1, wherein promoting the one or social networking objects comprises:
converting the content into a sponsored story;
bidding on the sponsored story in an advertisement system; and
as a result of the bidding, displaying the sponsored story in a sponsored story area of a set of particular other users' pages.

9. A non-transitory computer-readable storage media containing instructions, the instructions operable to, when executed by one or more computer systems:
receive, from a first user of a social networking system, a request to sponsor content, the request comprising an identifier for one or more social networking objects viewable by other users of the social networking system;
promote the one or more social networking objects to the other users of the social networking system; and
debit an account of the first user based on the promoting of the one or more social networking objects.

10. The media of claim 9, wherein promoting the one or more social networking objects comprises pin the one or more social networking objects to a predetermined location of a personalized activity stream for each of the other users.

11. The media of claim 10, wherein the one or more social networking objects are promoted for a predetermined amount of time.

12. The media of claim 11, wherein the predetermined amount of time is a predetermined number of log-ins to the social networking system.

13. The media of claim 9, wherein the payment is a predetermined amount of credits.

14. The media of claim 9, wherein promoting the one or more social networking objects comprises weighing the one or more social networking objects more heavily in a content ranking algorithm.

15. The media of claim 14, wherein the content ranking algorithm is based on at least a coefficient between a first node representing the first user and each of a set of second nodes, each second node representing one of the other users.

16. The media of claim 9, wherein promoting the one or social networking objects comprises:
convert the content into a sponsored story;
bid on the sponsored story in an advertisement system; and
as a result of the bidding, display the sponsored story in a sponsored story area of a set of particular other users' pages.

17. A system comprising:
one or more processors;
one or more non-transitory computer-readable media containing instructions, the instructions operable to, when executed by the one or more processors:
receive, from a first user of a social networking system, a request to sponsor content, the request comprising an identifier for one or more social networking objects viewable by other users of the social networking system;
promote the one or more social networking objects to the other users of the social networking system; and
debit an account of the first user based on the promoting of the one or more social networking objects.

18. The system of claim 17, wherein promoting the one or more social networking objects comprises pin the one or more social networking objects to a predetermined location of a personalized activity stream for each of the other users.

19. The system of claim 18, wherein the one or more social networking objects are promoted for a predetermined amount of time.

20. The system of claim 19, wherein the predetermined amount of time is a predetermined number of log-ins to the social networking system.
